(19) United States
(12) Patent Application Publication
(10) Pub. No.: US 2002/0090190 A1
(43) Pub. Date: Jul. 11, 2002

(54) Efficient curved waveguide

(76) Inventors: Wenhua Lin, Pasadena, CA (US); Chi Wu, San Marino, CA (US)

Correspondence Address: Terrance A. Meador, Gray Cary Ware & Freidenrich, Suite 1600, 4365 Executive Drive, San Diego, CA, 92121, US

(21) Appl. No.: 09/756,498

(22) Filed: Jan. 8, 2001

(51) Int. Cl. G02B 6/122

(52) U.S. Cl. 385/132; 385/129

(57) ABSTRACT

A waveguide is disclosed. The waveguide includes a first side defining a first portion of a light signal carrying region and a second side defining a second portion of the light signal carrying region. The second side is positioned opposite the first side and at least a portion of the second side is taller than the first side. In one embodiment, at least a portion of the waveguide has a curve with an inside and an outside. The second side is positioned on the inside of the curve and the first side is positioned on the outside of the curve.

### BACKGROUND

1. Field of the Invention

The invention relates to one or more optical networking components. In particular, the invention relates to a waveguide.

2. Background of the Invention

A variety of optical components employ curved waveguides. For instance, optical multiplexers often include an arrayed waveguide grating connecting two star couplers. The arrayed waveguide grating typically includes a plurality of curved waveguides that carry light signals between the star couplers.

Waveguides are associated with a particular level of optical loss in that a fraction of the light signal carried in a waveguide is lost as the light signal travels along the waveguide. The optical loss that occurs in curved waveguides is typically greater than what would occur when using the same waveguide in a straight configuration. This increased optical loss is a result of the fundamental mode shifting toward the outside of the curve in the waveguide. Accordingly, optical components that employ curved waveguides experience more optical loss than components employing straight waveguides.

For the above reasons, there is a need for a curved waveguide that is not associated with increased optical losses.

### SUMMARY OF THE INVENTION

The invention relates to a waveguide. The waveguide includes a first side defining a first portion of a light signal carrying region and a second side defining a second portion of the light signal carrying region. The second side is positioned opposite the first side and at least a portion of the second side is taller than the first side.

In one embodiment, at least a portion of the waveguide has a curve with an inside and an outside. The second side is positioned on the inside of the curve and the first side is positioned on the outside of the curve.

Another embodiment of the waveguide includes a light signal carrying region for carrying light signals in a plurality of modes. The waveguide also includes a grating positioned adjacent to the light signal carrying region. The grating is configured to divert at least a portion of one or more of the modes from the light signal carrying region.

### BRIEF DESCRIPTION OF THE FIGURES

FIG. 1 illustrates a demultiplexer that employs curved waveguide.

FIG. 2 is a cross section of a component having a curved waveguide.

FIG. 3A to FIG. 3D illustrate different embodiments of a top side of a waveguide according to the present invention.

FIG. 4A illustrates a waveguide having a curved portion abruptly transitioning into a straight portion.

FIG. 4B through FIG. 4D illustrate waveguides having a curved portion smoothly transitioning into a straight portion.

FIG. 5A illustrates a profile for a fundamental mode of a light signal carried in a light signal carrying region of the present invention.

FIG. 5B illustrates profile for high order modes of light signals carried in a light signal carrying region of the present invention.

FIG. 6A to FIG. 6C illustrate an embodiment of a component having a grating for diverting at least a portion of a mode from a light signal carrying region.

FIG. 6D illustrates another embodiment of a component having a grating for diverting at least a portion of a mode from a light signal carrying region. The component includes a plurality of waveguides that are each associated with a different grating.

FIG. 7A to FIG. 7C illustrate an embodiment of a component having a straight waveguide and a grating for diverting at least a portion of a mode from a light signal carrying region.

FIG. 8A to FIG. 8F illustrate a method of forming a component having a grating adjacent to a waveguide. The waveguide having a second side taller than a first side.

FIG. 9A to FIG. 9F illustrate another embodiment of a method for forming a component having a grating adjacent to a waveguide. The waveguide having a second side taller than a first side.

### DETAILED DESCRIPTION OF THE PREFERRED EMBODIMENT

The invention relates to a waveguide. The waveguide includes a first side defining a first portion of a light signal carrying region and a second side defining a second portion of the light signal carrying region. The first side is opposite the second side. The second side is taller than the first side.

When the waveguide is curved, the second side is positioned on the inside of the curve and the first side is positioned on the outside of the curve. Accordingly, the taller side is positioned on the inside of the curve. Increasing the height of the side on the inside of the curve increases the effective index of refraction near the inside of the curve. The increase in the index of refraction near the inside of the curve shifts the light signal toward the inside of the curve. As a result, the optical loss associated with shifting the light signals toward the outside of the curve are reduced in waveguides according to the present invention. Further, the reduced optical losses allow waveguides according to the present invention to be curved more sharply than prior waveguides.

The light signals can travel in the waveguide in more than one mode. The fundamental mode is frequently the desired mode while the higher order modes are often not desired. In one embodiment of the invention, a grating is positioned adjacent to the light signal carrying region. The grating can be designed to divert at least a portion of one or more of the undesirable modes from the light signal carrying region. Accordingly, the intensity of the one or more undesirable modes in the light signal carrying region is reduced.

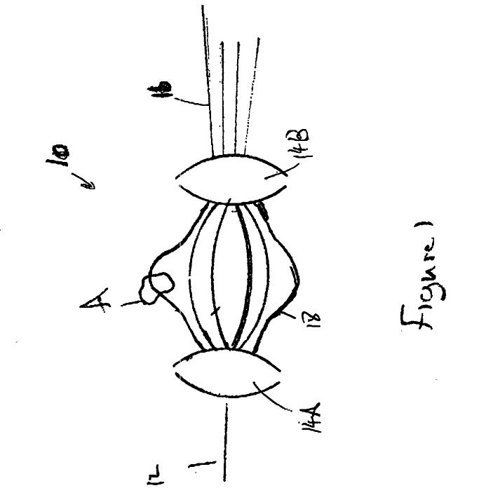

FIG. 1 illustrates an optical component 10 that employs curved waveguides. The illustrated component 10 is a demultiplexer. The component 10 includes an input waveguide 12 in optical communication with a first star coupler 14A and a plurality of output waveguides 16 in optical communication with a second star coupler 14B. A plurality of phase differentiation waveguides 13 provide optical communication between the first star coupler 14A and the second star coupler 14B. The phase differentiation waveguides 13 each have a length that is different than the length of the adjacent waveguide by a constant length, ΔL. In order for the phase differential waveguides to have different lengths and connect the first and second star coupler 14B, at least a portion of the waveguides have a curved shape.

During operation of the component 10, light signals from the input waveguide 12 enter the first star coupler 14A which distribute each light signal to a plurality the phase transition waveguides. The light signals travel through the phase transition waveguides into the second star coupler 14B. The light signal from each phase transition waveguide enters the second waveguide in a different phase. The phase differential causes the light signal to be focussed at a particular one of the output waveguides 16. The output waveguide 16 on which the light signal is focussed is a function of the wavelength of light of the light signal. Accordingly, light signals of different wavelengths are focussed on different output waveguides 16.

Other publications, such as U.S. Pat. No. 5,243,672, provide more detailed descriptions of the operation of optical multiplexers and demultiplexers.

FIG. 2 illustrates a, portion of a component 10 having a curved waveguide 20. The illustrated component 10 could be the portion of the demultiplexer of FIG. 1 shown in the region labeled A. The component 10 includes a first side 22 and a second side 24. The component 10 further includes a light barrier 26 formed over a substrate 28. A first light transmitting medium 30 is positioned over the light barrier 26. The first light transmitting medium 30 is formed into a ridge 32. A light signal carrying region 34 is formed between the ridge 32 and light barriers 26. A profile of a light signal carried in the light signal carrying region 34 is shown by the line labeled A. The light barrier 26 prevents leakage of light from the waveguide into the substrate 28. Accordingly, the light barrier 26 restrains the light signal to the light signal carrying region 34.

The ridge 32 includes two opposing sides that define the light signal carrying region 34. The second side 36 is positioned on the inside of the curve and the first side 38 is positioned on the outside of the curve. The second side 36 is taller than the first side 38.

As illustrated by the light signal profiles in FIG. 2, increasing the height of the second side 36 shifts the profile of the light signal away from the first side 38 of the ridge 32 and toward the second side 36 of the ridge 32. The light signals carried by prior curved waveguides 20 often leaked as indicated by the arrow labeled C in FIG. 2. The light signal is also shifted in a direction that is opposite to the arrow labeled C. Shifting the light signal away from the normal direction of leakage reduces the leakage of the light signal from the light signal carrying region 34 and accordingly increases the efficiency of the waveguide.

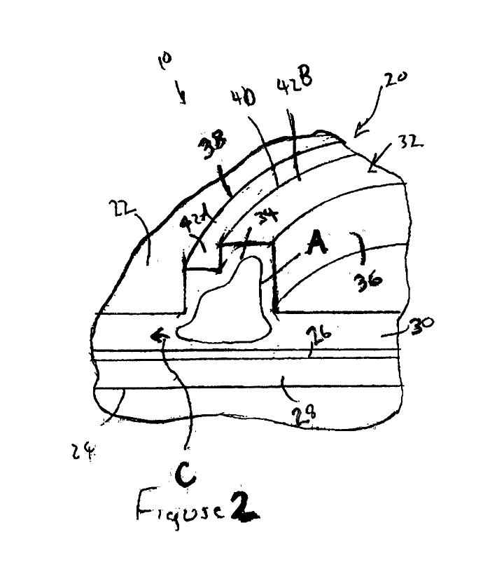

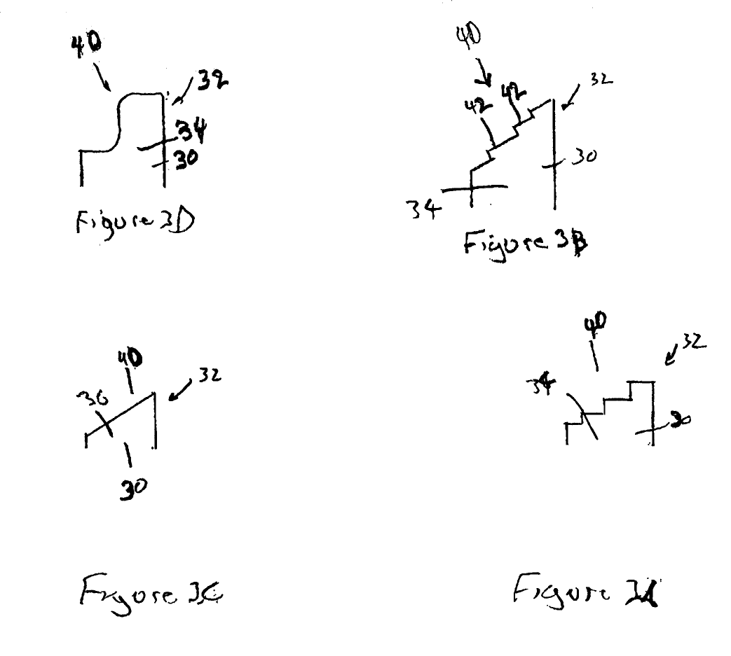

The top side 40 of the ridge 32 connects the first side 38 and the second side 36. The top side 40 illustrated FIG. 2 has a first surface 42A connected to the first side 38 and a second surface 42B connected to the second side 36. The first surface 42A and the second surface 42B are arranged in a step configuration. The top side 40 can include more than two surfaces 42 as shown in FIG. 3A and FIG. 3B. The surfaces 42 are arranged in a step wise pattern. Alternatively, the top side 40 can include a single sloped surface 42 as shown in FIG. 3C. Further, the top side 40 can include a surface 42 that is curved between the first side 38 and the second side 36 as shown in FIG. 3D. Other configurations for the top side 40 are possible.

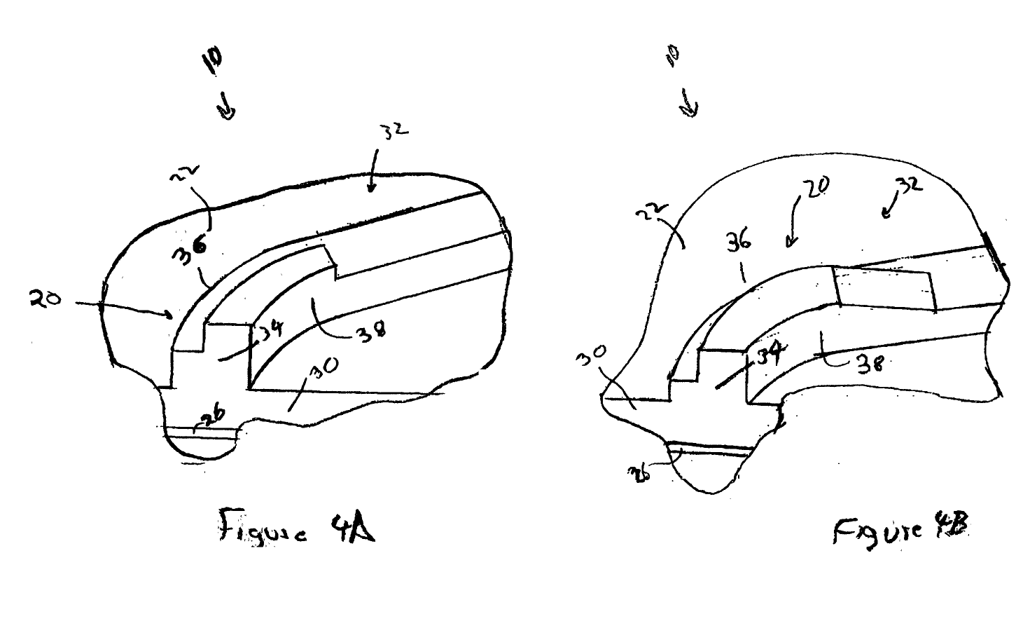

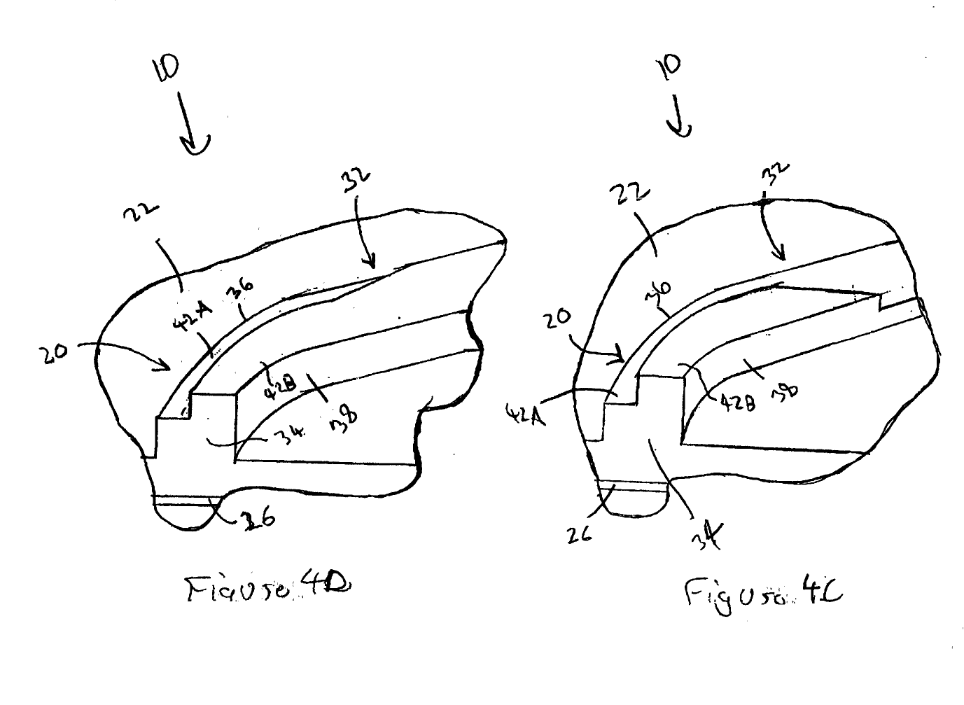

As illustrated in FIG. 4A through FIG. 4D, a single waveguide can include a straight portion and a curved portion. Although the straight portion of the waveguide can include a second side 36 that is taller than a first side 38, the waveguide can transition from having a second side 36 taller than a first side 38 to having a second side 36 that is substantially the same height as the first side 38. The transition can occur anywhere along the waveguide or where a curved portion of the waveguide transitions to a straight portion of the waveguide. The transition can be an abrupt transition as shown in FIG. 4A. The transition can also be a smooth transition as shown in FIG. 4B. In one embodiment of a smooth transition, the second surface 42 merges into the second side as shown in FIG. 4C. A smooth transition can reduce excitation of higher order modes.

Although FIG. 4A through FIG. 4C illustrate the second side transitioning from having a taller height than the first side to having the same height as the first side. The first side can transition from being shorter than the second side to being the same size or taller than the first side as shown in FIG. 4D. Waveguides having a transition region shown in FIG. 4C and FIG. 4D may be easier to fabricate due to the limitations of mask and etch technology.

The waveguide can be designed such that the portion of the wave guide having a first side 38 and a second side 36 of substantially the same height, the portion having a second side 36 taller than the first side 38 and the transition portion all have substantially the same cross sectional area. Preserving the cross sectional area can also reduce excitation of higher order modes.

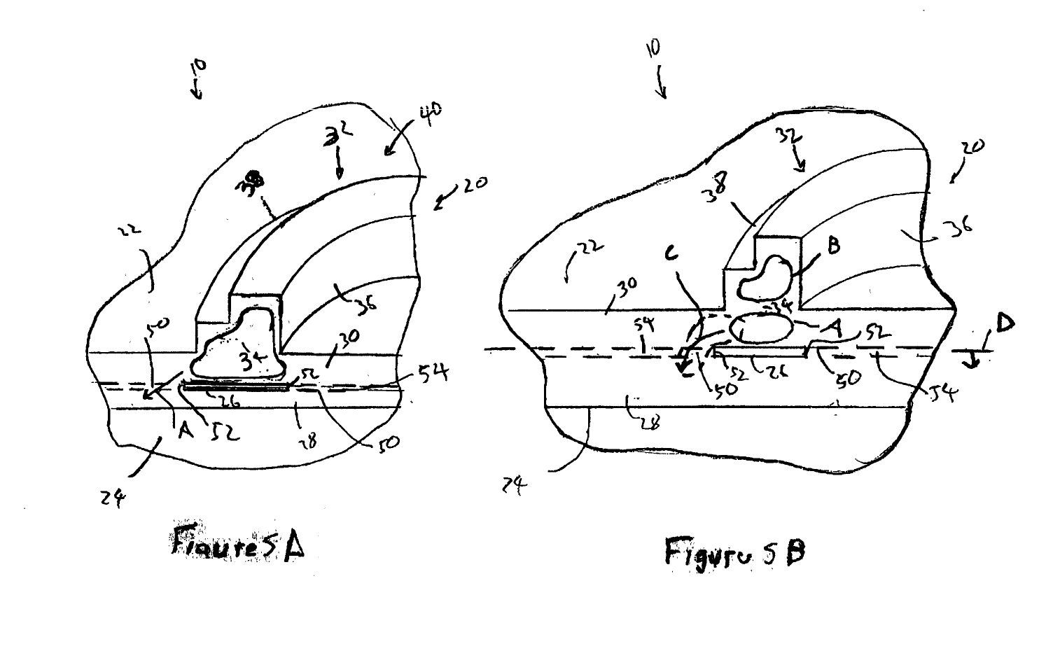

The component 10 can include drains 50 positioned adjacent to sides 52 of the light barrier 26 as shown in FIG. 5A. A second light transmitting medium 54 is positioned adjacent to at least one side of the light barrier 26. The second light transmitting medium 54 is positioned to receive at least a portion of the light that exits from the light signal carrying region 34. The light that is received by the second light transmitting medium 54 enter the substrate 28 as shown by the arrow labeled A. Further, a bottom of the substrate 28 can include an anti-reflective coating to encourage the light signal exiting the substrate 28. Accordingly, the second light transmitting medium 54 serves as a drain 50 that drains light that exits the light signal carrying regions 34 from a waveguide and/or from the component 10. Because the light is drained from the component 10, the light represented by the arrows labeled A does not enter adjacent waveguides and accordingly is not a source of cross talk.

The substrate 28, the first light transmitting medium 30 and the second light transmitting medium 54 can be formed of the same or different materials. For instance, the substrate 28, the first light transmitting medium 30 and the second light transmitting medium 54 can all be silicon while the light barrier 26 is air or silicon dioxide. Alternatively, the substrate 28 and the second light transmitting medium 54 can be silicon and the first light transmitting medium 30 can be silicon dioxide, while the light barrier 26 is air. Further, the substrate 28 can be silicon, the first light transmitting medium 30 can be GaAs, InP, SiN, SiGe, LiNbO3 or silicon and the second light transmitting medium 54 can be GaAs, InP, SiNx, SiONx, SiGe, or LiNbO3. The use of GaAs or InP allow the component 10 to be used for high speed applications. The materials for light signal carrying region 34, substrate 28, and light barrier 26 include, but not limited to, GaAs and its compounds, such as AlGaAs; InP and its compounds, such as InGaAsP, InAlAsP; Silicon and its compounds, such as SiGe, SiC, SiGeC, SiN, SiGaN; LiNbO₃ and other refractive materials; SiO₂, SiONx, SiNx, low dielectric constants material, such as SiCOH; porous SiO₂, polymer material; and air. When the light carrying region is Silicon, GaAs or InP, the light barrier 26 could be SiO₂, SiNx, SiONx, SiCOH, porous Si, porous SiO₂ or air.

The light barrier 26 can have reflective properties such as a metal layer or a metal coating. Alternatively, the light barrier 26 can be a material that transmits light but causes more light reflection at the intersection of the light barrier 26 and the first light transmitting material than is caused at the intersection of the first light transmitting medium 30 and the second light transmitting medium 54. The light reflection caused by the light barrier 26 can result from a change in the index of refraction between the light barrier 26 and the first light transmitting medium 30. For instance, the light barrier 26 can be silicon dioxide or air when the first light transmitting medium 30 is silicon. When the light reflection results from a change in the index of refraction, a portion of the light will be transmitted through the light barrier 26. Accordingly, suitable light barriers 26 need only stop passage of a relevant portion of the light and not block passage of all the light.

Light signals traveling in the light signal carrying region 34 can travel in one or more modes. The profile of the light signal shown in FIG. 5A is the profile of a light signal traveling in the fundamental mode. FIG. 5B shows a high order mode labeled A and high order mode labeled B. The fundamental mode is generally the most desired mode for use in optical components 10. The higher order modes can have an adverse affect on the fundamental mode. As a result it is often desirable to remove the higher order modes.

The higher order mode labeled A leaks from the waveguide as shown by the arrow labeled C. The drain 50 serves to drain this mode from the waveguide and accordingly reduce the amount of cross talk.

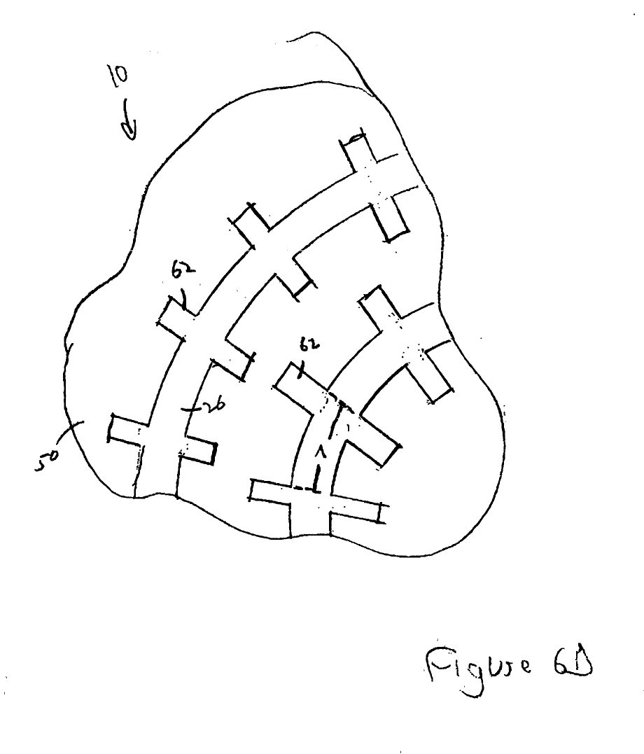

The component 10 can include a grating 60 positioned adjacent to the light signal carrying region 34 in order to reduce the affects of the mode labeled B. FIG. 6A through FIG. 6C are cross sections of a component 10 including a grating 60. The illustrated component 10 has a plurality of waveguides. The cross section shown in FIG. 6A is taken at the Level of the light barrier 26 looking down on the optical component. FIG. 6B is a cross section of the component 10 illustrated in FIG. 6A taken at the line labeled A and FIG. 6C is a cross section of the component 10 illustrated in FIG. 6A taken at the line labeled B.

A grating 60 is positioned adjacent to the light signal carrying region 34. The grating 60 includes a plurality of grating members 62. The grating members 62 are illustrated as being connected to the light barrier 26, however, the grating members 62 can be spaced apart from the light barrier 26. Further, the grating members 62 need not be positioned in the same plane as the light barriers 26. For instance, the grating members 62 can be raised above the level of the light barriers 26 toward the ridge 32 in order to reduce the distance between the light signal carrying region 34 and the grating members 62. Alternatively, the grating members 62 can be positioned below the level of the light barriers 26 further from the ridge 32 in order to increase the distance between the light signal carrying region 34 and the grating members 62. When the grating members 62 are not positioned in the same plane with the light barrier 26, the grating members 62 can extend across the waveguide.

Although the waveguides on the component of FIG. 6A through FIG. 6C are illustrated as being associated with a single waveguide. The waveguides can each be associated with a different grating as shown in FIG. 6D. Although the grating members are shown to be substantially perpendicular to the waveguide, the grating members can have other orientations relative to the waveguide. For instance, the grating members can be substantially parallel to one another.

Having a grating associated with each waveguide allows the grating to be designed for a particular waveguide without taking into account adjacent waveguides. For instance, when one grating member is associated with more than one waveguide, the waveguide member might cross the waveguides at different angles. When the grating member is associated with a single waveguide, the grating member can be positioned at the desired orientation relative to the associated waveguide.

The grating can extend along the full length of the waveguide or can be positioned adjacent to only a portion of the waveguide. For instance, when a portion of the waveguide is associated with the negative affects of a particular mode, a grating 60 can be formed adjacent to that portion of the waveguide.

The grating members 62 can be constructed from the same material as the light barrier 26 or from a material that is different from the light barrier 26.

The grating 60 is configured such that at least a portion of the high order mode labeled B is diverted from the light signal carrying region 34 as illustrated in FIG. 6B by the arrows labeled B. For instance, the grating 60 can be configured to couple the high order mode with the substrate 28. The effect of this coupling is to divert at least a portion of the high order mode from the light signal carrying region 34 and into the substrate 28. Accordingly, the grating 60 reduces the intensity of the high order mode in the light signal carrying region 34. Because the grating 60 reduces the intensity of the high order mode, the effects of the high order mode on the other modes in the light signal carrying region 34 is also reduced.

Equation 1 can be used to design a grating 60 that couples the high order mode with the substrate. The N th mode that meets equation 1 will be selectively coupled into the substrate. In Equation 1, Δ is the side to side spacing of the grating members 62 illustrated in FIG. 6A. When the waveguide is weakly coupled to adjacent waveguides, β_{N} can be approximated as the propagation constant of the N th mode that is being coupled and β_{S} can be approximated as the propagation constant of the substrate 28. When the waveguide is coupled to an adjacent waveguide, β_{N} and β_{S} can be approximated as the supermodes.

|β_{N}−β_{S}|=2π/Λ (1)

Design of the grating 60 takes into consideration a single wavelength of light called the design wavelength below. However, the waveguide will often carry several different wavelengths of light. The grating 60 will divert a distribution of wavelengths having the approximate shape of a sinc function and centered around the design wavelength. When it is desired to divert as many of the wavelengths of light as possible, the wavelength used in the design of the grating 60 can be a function of the various wavelengths. For instance, the design wavelength can be an average of the wavelengths traveling in the mode to be coupled, the mode of the wavelengths traveling in the mode to be coupled or an average of the high and low wavelengths traveling in the mode to be coupled. Alternatively, when it is desired to remove a single wavelength of light, the design wavelength can be equal to that wavelength.

Although Equation 1 is disclosed for design of a grating 60 for removing the high order mode labeled B, the equation can be used to design a grating that will divert other modes from the light signal carrying region 34.

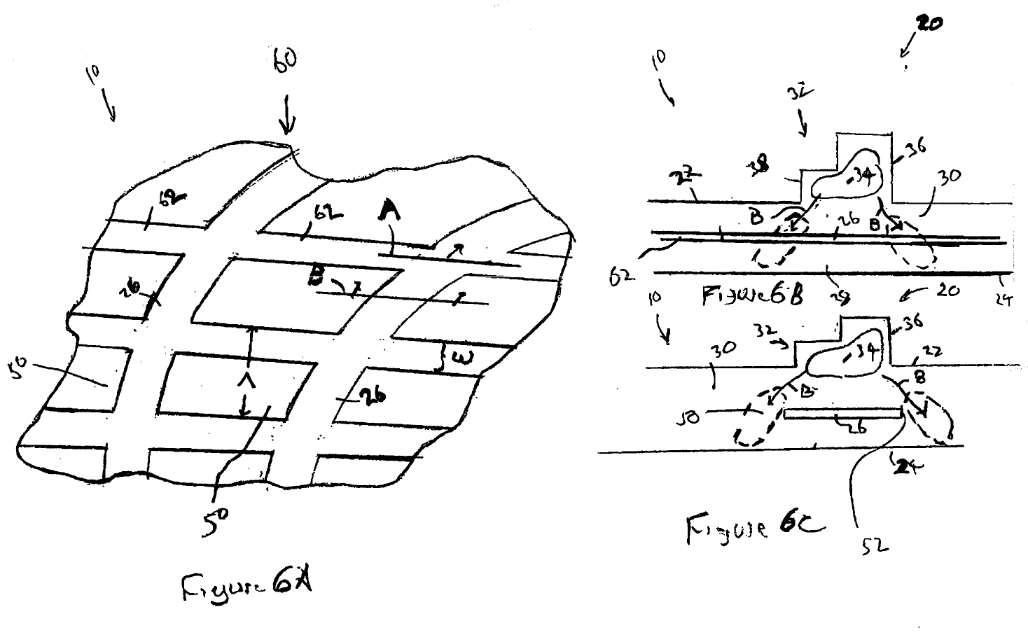

Although the grating 60 is disclosed in the context of a curved waveguide 20, the grating 60 can be used in conjunction with straight waveguides. Additionally or alternatively, the grating 60 can be used in conjunction with waveguides having a ridge 32 with a first side 38 and a second side 36 of the same height. For instance, FIG. 7A through FIG. 7C are cross sections of a component 10 including a grating 60 used in conjunction with a straight waveguide and a ridge 32 having a first side 38 with the same height as a second side 36. FIG. 7A is a top view of a light barrier 26 and grating members 62 formed in a component 10. FIG. 7B is a cross section of the component 10 illustrated in FIG. 7A taken at the line labeled A and FIG. 7C is a cross section of the component 10 illustrated in FIG. 7A taken at the line labeled B. The grating 60 is designed so as to divert at least a portion of the mode labeled B from the light signal carrying region 34. The mode labeled A can be drained from the light signal carrying region 34. Accordingly, the fundamental mode illustrated in FIG. 7C will be the primary mode carried in the waveguide.

The grating 60 can also be used with a continuous light barrier 26 illustrated in the component 10 of FIG. 2. However, the grating members 62 are positioned between the first side 22 of the component 10 and the light barrier 26. The grating members 62 can be formed into the top surface 42 of the light barrier 26 or can be formed apart from the light barrier 26. The grating members 62 can be sized such that they extend through the light signal carrying region 34.

Although the grating 60 is described for the purposes of reducing the effects of a higher order mode, the component 10 can include the barrier positioned adjacent to a drain 50 but not include a grating 60.

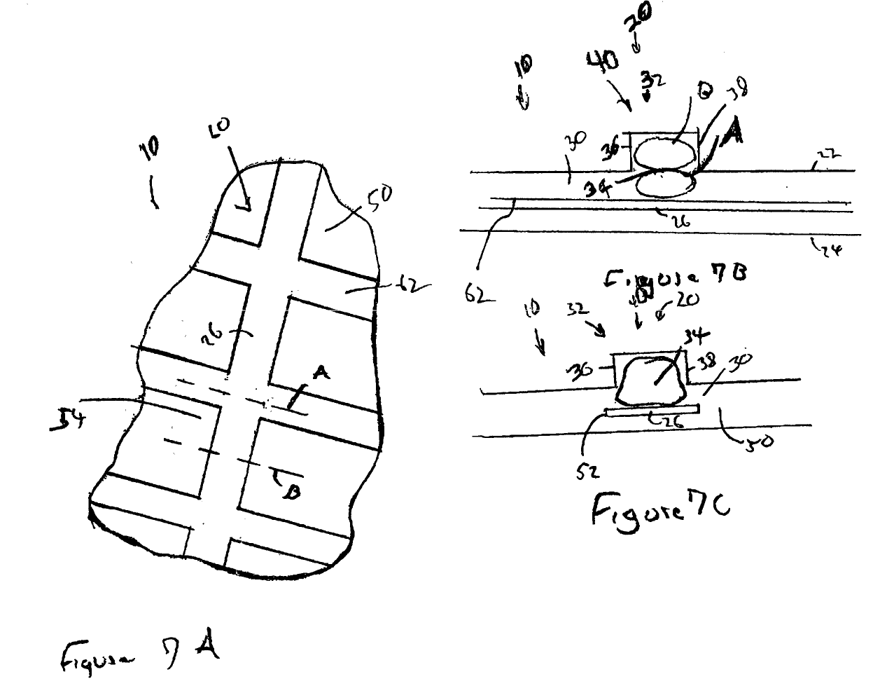

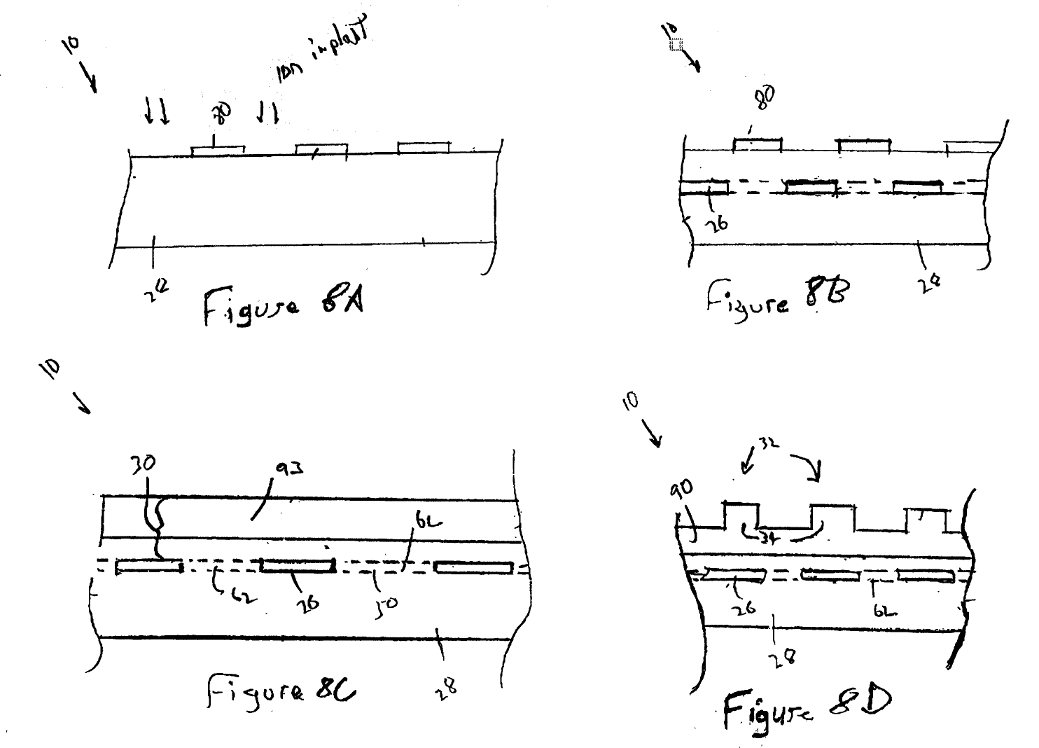

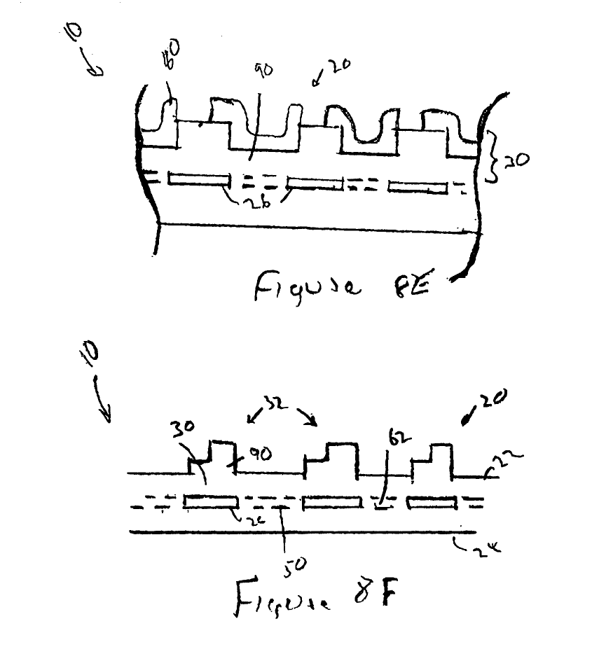

FIG. 8A through FIG. 8F illustrates a method for fabricating a component 10 having a waveguide adjacent to a grating 60 and having a ridge with a second side 36 that is taller than a first side 38. FIG. 8A shows a plurality of masks 80 formed on a substrate 28. Suitable substrates 28 include, but are not limited to, silicon substrates 28. The masks are formed such that regions of the substrate 28 where the light barriers 26 and grating members 62 are to be formed remain exposed. An ion implant such as an O₂ ion implant is performed. After annealing, the light barrier 26 and grating members 62 are formed between the masks as shown in FIG. 8B. For instance, when the ion implant is an O₂ ion implant and the substrate 28 is a silicon substrate 28, the annealing forms silicon dioxide light barriers 26. The masks are removed and a light transmitting medium 90 such as silicon is grown on the substrate 28 as shown in FIG. 8C. A mask is formed such that the regions of the light transmitting medium 90 where waveguides are to be formed is exposed. An etch is performed and the masks are removed to provide the component 10 shown in FIG. 8D. The component 10 is then masked as shown in FIG. 8E. An etch is then performed and the masks removed to provide the component 10 illustrated in FIG. 8F. In some instances, there is no need to attach light transmitting medium shown in FIG. 8C and the substrate 28 can be etch so as to form waveguides and/or light distribution devices.

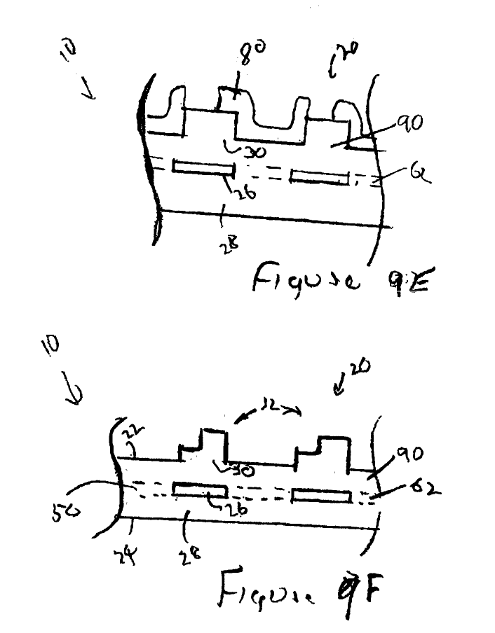

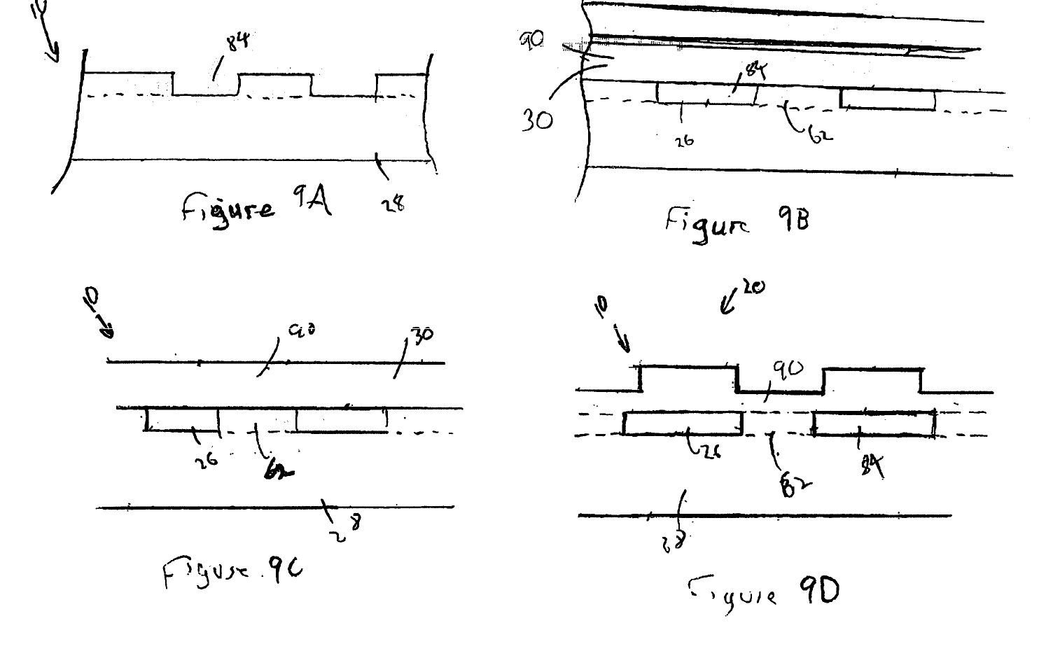

FIG. 9A through FIG. 9F illustrate a method for fabricating a component 10 having a waveguide adjacent to a grating 60 and having a ridge with a second side 36 that is taller than a first side 38. A mask and etch is performed on a substrate 28 such as silicon to provide grooves 84 as illustrated in FIG. 9A. The light barriers 26 and any grating members will be formed in the grooves 84. Air can be left in the grooves 84 or another light barrier 26 material can be deposited in the grooves 84. A chemical mechanical planarization (CMP) process can be used to smooth the surface of the grooves 84. Wafer bonding techniques can then be applied to attach a light transmitting medium 90 such as silicon on insulator wafer to the component 10 as shown in FIG. 9B or to attach a silicon wafer to the component 10 as shown in FIG. 9C. When a silicon on insulator wafer is attached, the top silicon layer and the silicon dioxide layer are etched to provide the component 10 shown in FIG. 9C. The light transmitting medium 90 is then masked and etched to provide the component 10 illustrated in FIG. 9D. The component 10 is then masked as shown in FIG. 9E. An etch is then performed and the masks removed to provide the component 10 illustrated in FIG. 9F. When a silicon wafer is attached to the substrate 28 through wafer bonding, the silicon wafer can be etched to the thickness needed for the light transmitting medium 90. This process has the advantage of lower cost, compared with the use of silicon-on-insulator substrate 28, but the thickness of the light signal carrying region can not be well controlled during the CMP process or other etching process.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. A waveguide, comprising:
a first side defining a first portion of a light signal carrying region; and
a second side defining a second portion of the light signal carrying region and being positioned opposite the first side, at least a portion of the second side being taller than the first side.

2. The waveguide of claim 1, wherein the waveguide is curved and the second side is positioned on the inside of the curve and the first side is positioned on the outside of the curve.

3. The waveguide of claim 1, further comprising:
a top side defining a third portion of the light signal carrying region, the top side connecting the first side and the second side.

4. The waveguide of claim 3, wherein the top side includes an inclined surface extending from the first side to the second side.

5. The waveguide of claim 3, wherein the top side includes a first surface connected to the first side and a second surface connected to the second side.

6. The waveguide of claim 5, wherein the first surface and the second surface are parallel to one another.

7. The waveguide of claim 5, wherein a third surface connects the first surface and the second surface.

8. The waveguide of claim 5, wherein the first surface is substantially perpendicular to the first side and the second surface is substantially perpendicular to the second side.

9. The waveguide of claim 1, wherein at least two parallel surfaces connect the first side to the second side.

10. The waveguide of claim 1, further comprising:
a light barrier defining at least a portion of the light signal carrying region.

11. The waveguide of claim 1, wherein the light barrier includes a surface between sides 52 and a drain 50 is positioned adjacent to at least one side of the light barrier, the drain is configured to drain light away from the light signal carrying region.

12. The waveguide of claim 1, further comprising:
a grating positioned such that light signals carried in the light signal carrying region are exposed to the grating.

13. The waveguide of claim 12, wherein the grating is coupled with a mode of light transmission.

14. The waveguide of claim 12, wherein the grating is designed such that |B_{N}−B_{S}|=2π/Λ.

15. A waveguide, comprising:
a light signal carrying region for carrying light signals in a plurality of modes; and
a grating positioned adjacent to the light signal carrying region and being configured to divert at least a portion of one or more of the modes from the light signal carrying region.

16. The waveguide of claim 15, wherein the grating is configured to couple the one or more modes with a light transmitting medium.

17. The waveguide of claim 15, wherein the grating is configured to couple the one or more modes with a substrate.

18. The waveguide of claim 15, wherein the grating includes a plurality of grating members alternating with a light transmitting medium.

19. The waveguide of claim 15, wherein the light signal carrying region is partially defined by a surface of a light barrier, the surface of the light barrier being positioned between two sides of the light barrier.

20. The waveguide of claim 19, wherein the grating includes a plurality of grating members, the grating members and the light barrier being constructed from a continuous material.

21. The waveguide of claim 15 further comprising:
a first side and a second side defining a portion of the light signal carrying region and being positioned opposite one another, at least a portion of the second side being taller than the first side.

22. The waveguide of claim 19, wherein the light signal carrying region has a curve and the second side is positioned on an inside of the curve and the first side is positioned on an outside of the curve.

23. The waveguide of claim 15, wherein the grating includes grating members, the grating members being constructed from a material selected from the group consisting of air and silicon dioxide.
